(19) United States
(12) Patent Application Publication
(10) Pub. No.: US 2009/0263221 A1
(43) Pub. Date: Oct. 22, 2009

(54) Apparatus For Loading/Unloading Drill Pipe

(76) Inventor: Paul Oldershaw, Houston, TX (US)

Correspondence Address: KLEIN, DENATALE, GOLDNER, COOPER et. al., P.O. BOX 11172, BAKERSFIELD, CA, 93389-1172, US

(21) Appl. No.: 12/425,162

(22) Filed: Apr. 16, 2009

Related U.S. Application Data
(60) Provisional application No. 61/124,553, filed on Apr. 16, 2008.

(51) Int. Cl. B60P 1/02; E21B 19/14

(52) U.S. Cl. 414/495

(57) ABSTRACT

A device for assisting in the loading and off-loading of oil well tubulars from a trailer comprising a frame, a bottom side and a top side defining a bed. The bed comprises a front and a back defining a longitudinal axis. A bin retaining the tubulars may be formed by upright members and attached to the frame. At least two horizontal pipe support members may be oriented transverse to the bed of the trailer and raising-lowering means may be provided for the horizontal pipe support members. The horizontal pipe support members may be raised in near simultaneous manner. The raising-lowering means may comprise a ram member comprising an extendable piston, wherein the piston extends and retracts in parallel alignment with the longitudinal axis of the trailer. The raising-lowering means may further comprise cable members attached at a first end to the piston, and attached at a second end to the horizontal pipe support members, and may comprise a plurality of pulleys.

### CROSS-REFERENCE TO RELATED APPLICATIONS

U.S. Provisional Application No. 61/124,553 for this invention was filed on Apr. 16, 2008, for which application these inventors claims domestic priority.

### BACKGROUND

The present invention generally relates to utility trailers. The present invention more specifically relates to various embodiments of a device for assisting in the loading and off-loading of oil well tubulars, including drill pipe, drill collars, casing, tubing, and sucker rods from delivery trailers to and from pipe racks, which are adjacent to a drilling rig work-over rig. The drill pipe, drill collars, casing, tubing and sucker rods, which are hereinafter collectively referred to as “tubulars”, are utilized in the drilling and production of oil and gas wells.

The handling of the tubulars utilized used in oil drilling and production operations presents difficult problems and potential hazards to the persons involved in manipulating the tubulars. These items are long and heavy, and are therefore difficult to handle because of the weight and length. Additionally the tubulars are relatively expensive. Being heavy and metallic, these items are often viewed by handling personnel as virtually indestructible, however the tubulars are not immune to damage from handling abuse. For example, threads can be damaged from impact with other tubulars, pipe racks, or the ground. Because the tubulars are heavy, it can be very cumbersome and dangerous to move joints of pipe back and forth between the trailer and the pipe rack. In addition, the tubulars can be damaged from being dropped significant distances.

Tubulars are typically delivered to onshore well locations with pipe trailers. The pipe trailer typically has a bin or “basket” formed by upright members on each side of the trailer which retain the tubulars within the trailer. In order to be utilized in drilling and production operations, the tubulars must be transported from the trailer to a horizontal pipe rack known as the “cat walk.” From the cat walk, each pipe joint is lifted up a pipe ramp and raised to a vertical position within the rig derrick. Typically the pipe trailers are aligned parallel to the cat walk and the tubulars transferred from the trailer pipe rack, and then to the cat walk as drill pipe is required for the well. Conversely, when pipe is being laid down, the pipe will be lowered to the cat walk and then transferred to a pipe trailer for transport away from the site to a new location.

If the top row of pipe on the trailer bed is high enough, each joint of pipe can be rolled off of the trailer directly onto the pipe rack. However, as the stack of pipe is lowered within the bin of the trailer by the removal of the top rows of pipe, the pipe on the trailer becomes too low to simply roll onto the pipe rack and must be picked up for transfer onto the pipe rack. Alternatively, the height of the pipe rack may be too high for any of the tubulars on the trailer to be rolled directly from the trailer to the pipe rack. In these cases, a lifting machine, apparatus or mechanism must be utilized for moving the tubulars from the trailer to the pipe rack or, conversely, moving the tubulars from the pipe rack to a trailer.

The generally known method for transferring tubulars back and forth from a trailer to a pipe rack is to attach a line from either an A-frame truck or from the rig's winch around each pipe joint, and lift the pipe out of the trailer bin onto the pipe rack. Some devices have been conceived which have the specific function of transferring oilfield tubulars from truck trailers to pipe racks, such as the device shown in U.S. Pat. No. 2,617,547, which is a separate vehicle utilized to raise lengths of pipe from the ground or a trailer to a pipe rack. U.S. Pat. No. 2,676,715 discloses a truck having loading arms for raising pipe from the ground to a selected height above the bed of the truck. U.S. Pat. No. 3,810,553 illustrates a pipe handling device having the primary function of moving pipe from the pipe rack to the floor of the rig, but which apparently could also be utilized for lifting pipe from the ground level to the pipe rack. U.S. Pat. No. 4,236,861 shows a self-propelled pipe handler with a scissors lift which is generally described as having utility for lifting tubulars to the rig floor level. All of these devices utilize complicated lifting apparatus and have substantial moving parts, and do not provide a simple solution for transferring pipe from a trailer to a pipe rack and back to the trailer after the pipe has been laid down. Thus, a need exists for a simplified apparatus and method which provides for the transfer of oilfield tubulars from a trailer to a pipe rack and back to the trailer when the drilling operation has been completed.

### BRIEF DESCRIPTION OF THE INVENTION

The embodiments of the apparatus disclosed herein and the disclosed method provide a trailer-mounted pipe lifting/lowering system. The system comprises a trailer comprising a frame, a bottom side and a top side, and a bed comprising a front and a back. The bed has a longitudinal axis that is defined by the front and the back. A bin is formed by a plurality of upright members on each side of the trailer, and the bin retains the tubulars within the trailer. The trailer has ground engaging wheels on the bottom side, generally at the end of the trailer opposite the hitch or fifth wheel engagement point. There are at least two horizontal pipe support members oriented transverse to the bed of the trailer, and raising-lowering means for the horizontal pipe support members. The raising-lowering means raise the horizontal pipe support members in near simultaneous manner, such that in the course of being raised or lowered a first horizontal pipe support member is at approximately the same height as a second horizontal pipe support member. The horizontal pipe support members generally maintain the tubulars above the frame.

The raising-lowering means for the two horizontal pipe support members may comprise a ram member comprising an extendable piston, wherein the ram member is disposed along the approximate central axis of the trailer, where the piston extends and retracts in generally parallel alignment with the longitudinal axis of the trailer. The raising-lowering means may further comprise cable members attached at a first end to the piston, and attached at a second end to the horizontal pipe support members. The raising-lowering means may further comprise a plurality of pulleys which convert the force of the piston from a primary force directed along the longitudinal axis, to a plurality of vertical forces directed perpendicular to the longitudinal axis, wherein separate forces are applied at each end of each of the horizontal pipe support members by attaching a cable to each end of the horizontal pipe support members. The application of the vertical forces to the horizontal pipe support members act to either raise the horizontal pipe support members or to resist gravity and thus control the lowering of the horizontal pipe support members as the bin is being filled with additional rows of pipe.

### BRIEF DESCRIPTION OF THE DRAWINGS

FIG. 1 depicts how drill pipe and other tubulars may be lifted up the cat walk and raised to the rig floor.

FIG. 2 shows a top view of an embodiment of the present apparatus for assisting in the loading and off-loading of oil well tubulars.

FIG. 3 shows a side view of an embodiment of the apparatus for assisting in the loading and off-loading of oil well tubulars.

FIG. 4 schematically shows a top view of an embodiment of the raising/lowering means in the lowered position

FIG. 5 schematically shows a side view of an embodiment of the raising/lowering means in the lowered position.

FIG. 6 schematically shows a top view of an embodiment of the raising/lowering means in the raised position.

FIG. 7 shows schematically shows a side view of an embodiment of the raising/lowering means in the raised position.

FIG. 8 shows a partial top view of an embodiment of the raising-lowering means.

FIG. 9 shows partial side view of the embodiment of the raising-lowering means shown in FIG. 8.

FIG. 10 shows a rear view of an embodiment of the apparatus for assisting in the loading and off-loading of oil well tubulars, showing the device in the lowered position.

FIG. 11 shows a rear view of an embodiment of the apparatus for assisting in the loading and off-loading of oil well tubulars, showing the device in the raised position.

FIG. 12 shows a front view of an embodiment of the apparatus for assisting in the loading and off-loading of oil well tubulars, showing the device in the lowered position, as seen from the trailer hitch side.

FIG. 13 shows a front view of an embodiment of the apparatus for assisting in the loading and off-loading of oil well tubulars, showing the device in the raised position, as seen from the trailer hitch side.

FIG. 14 shows a side view of tubulars being offloaded from the apparatus for assisting in the loading and off-loading of oil well tubulars and loaded onto a pipe rack for eventual use.

### DETAILED DESCRIPTION

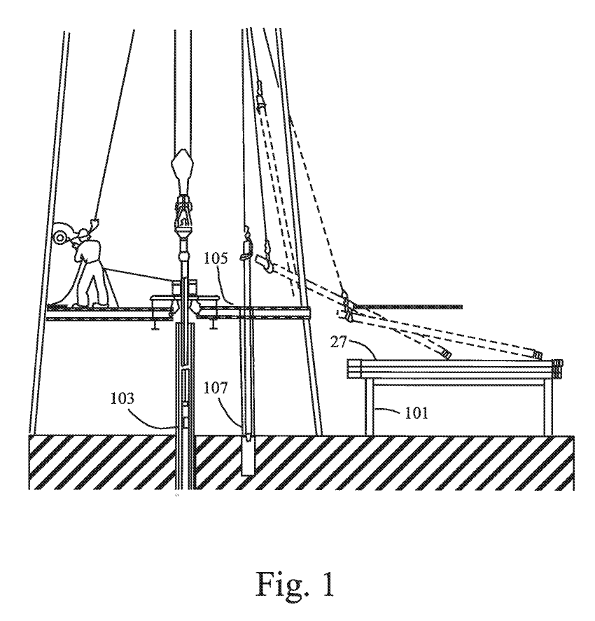

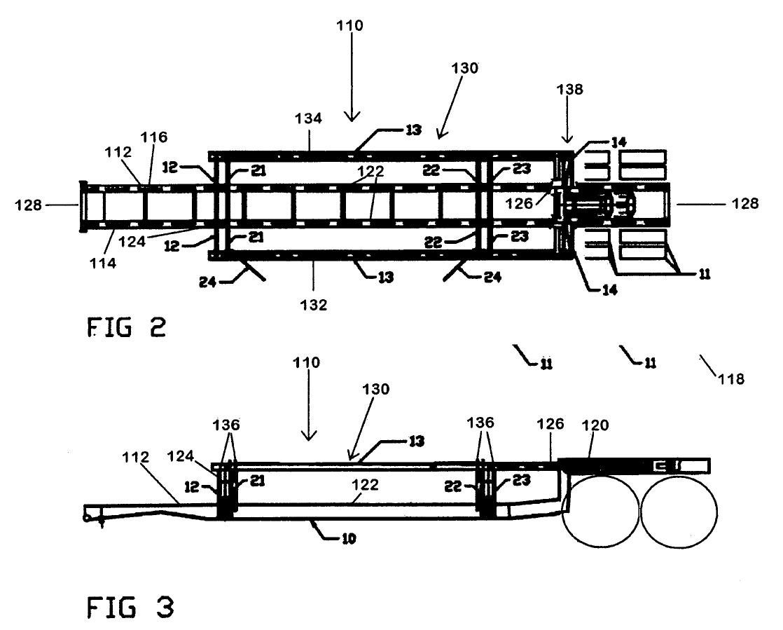

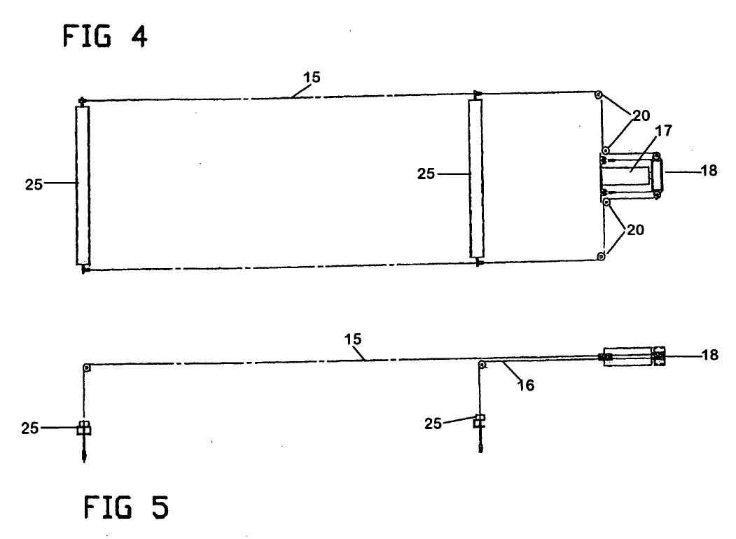

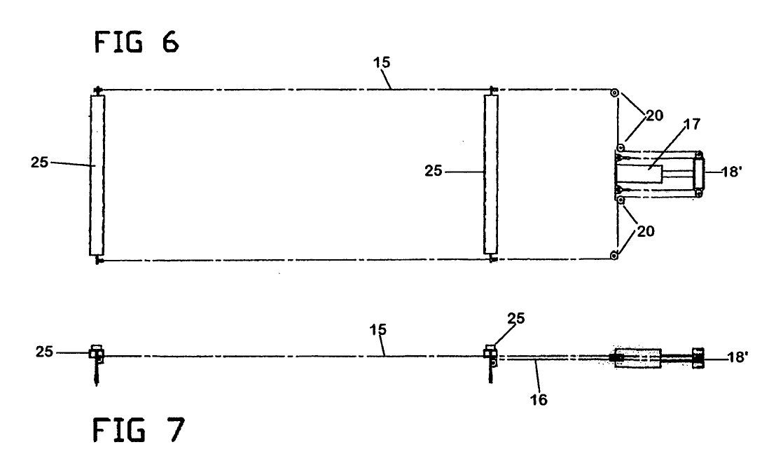

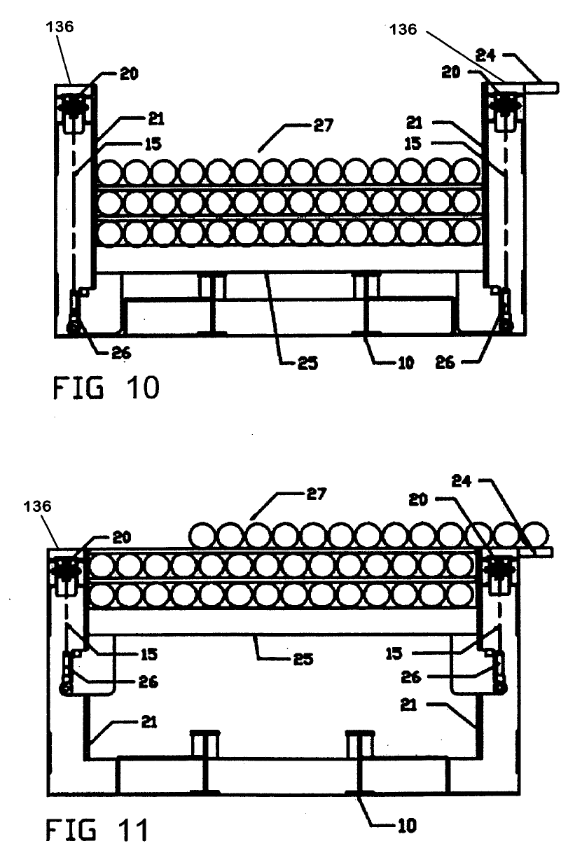

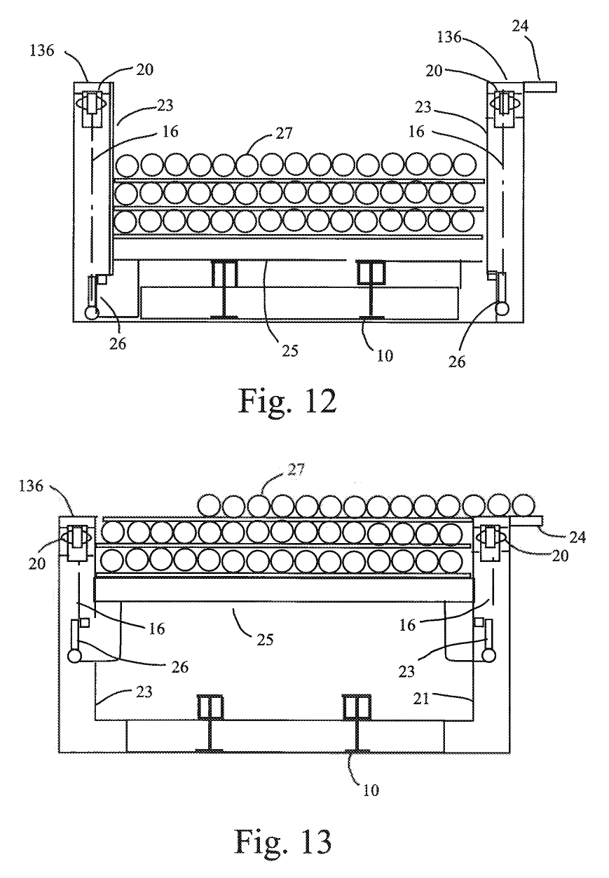

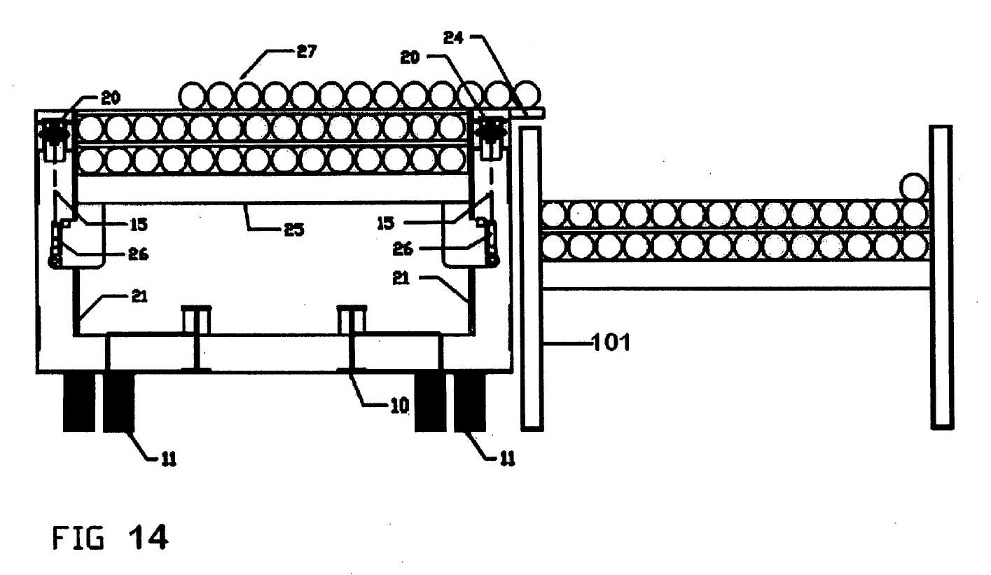

Referring now to the Figures, FIG. 1 shows the movement of tubulars, or drill pipe, from the pipe rack to the rig floor, and FIGS. 2 through 14 show various views of an embodiment of the disclosed device for assisting in the loading and off-loading of oil well tubulars. As seen in FIG. 1, the pipe 27 is generally stored in a horizontal position in a pipe rack 101, but must be raised to a vertical position for assembly and placement into the well 103. The raising and assembling occurs on the oil rig 105, and the tubulars 27 may be placed into a mouse hole 107 until the pipes 27 are needed.

The disclosed device 110 comprises a trailer 112 that would be pulled into place or moved by a truck. The trailer 112 comprises a frame 10 having a right side 114 and a left side 116, a bottom side 118, and a top side 120 defining a bed 122. A plurality of ground engaging wheels 11 are attached to the trailer bottom side 118, which assist in the movement of the trailer 112 if and when needed. The bed 122 comprises a front 124 and a back 126, and a longitudinal axis 128 is defined by the front 124 and the back 126. The longitudinal axis 128 comprises the length of the trailer 112 and is adjacent to the stored length of the tubulars 27. The tubulars 27 are stored in a bin 130 comprising a right side 132 and a left side 134, and the bin 130 may be formed by a plurality of upright members 136 attached to the corresponding right 114 and left 116 frame sides. The upright members 136 may comprise front support frames 12, 22, and rear support frames 21, 23. The bin 130 retains the tubulars 27 during movement as well as prior to unloading of the tubulars 27. There may be at least two horizontal pipe support members 25 oriented transverse to the bed 122, and the horizontal pipe support members 25 support the tubulars 27 at a point near the ends of the tubulars 27. The horizontal pipe support members 25 engage the underside of the bottom layer of tubulars 27. The horizontal pipe support members 25 are raised, such that the tubulars 27 are raised above the bin 130 so that they may be transported to the pipe rack 101. The top rows would be removed and used first.

The raising-lowering means 138 for the horizontal pipe support members 25 lift and elevate the tubulars 27 as they are used, and the bottom row of tubulars 27 might not need to be lifted to be removed from the bin. The raising-lowering means 138 may comprise a ram member 17 that comprises an extendable piston 18, and the extension of the piston 18 by the force exerted by the ram 17 causes the raising-lowering means 138 to raise the horizontal pipe support members 25. Likewise the retraction of the piston 18 as the ram 17 removes the force upon the piston 18 would allow gravity to assist in lowering the raising-lowering means 138 thereby lowering the horizontal pipe support members 25. The raising-lowering means 138 may further comprise cable members 15 attached at a first end to the piston 18, and attached at a second end to the horizontal pipe support members 25. The cables may be housed in a cable support frame 13, and the cable support frame 13 could extend the length of the carrying surface of the trailer 112 in a general U-shape configuration. The cable support frame may thus have a rear 14, and the cable support frame rear 14 could be used to house the sheaves or pulleys 20. The cables 15 may be attached to the piston 18 through cable end fittings 26 to assist in connecting the cables 15 to the piston. The cables 15 may further comprise turnbuckles 19 that could assist in taking up cable slack or releasing retained cable, depending upon the conditions and load.

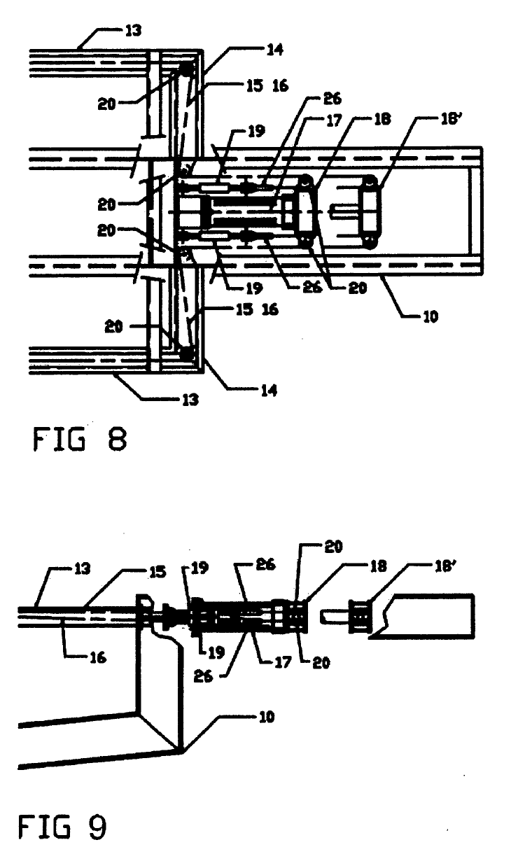

The extension of the piston from the ram 17 would transfer the generally horizontal force of the piston 18 to the cables and the cables 15, 16 would apply a generally vertical force to the horizontal pipe support members 25. The cable 15 members may comprise a first cable pair 15 attached to a first horizontal pipe support member and a second cable pair 16 attached to a second horizontal pipe support member. In this configuration the cables may be designated as an upper cable 15 and a lower cable 16. FIG. 8 shows the movement of the piston as it extends from a retracted position 18 to an extended position 18′ and this movement imposes a corresponding motion to the horizontal pipe support members 25, causing them to move from a lowered position to a raised position. The raising-lowering means 138 may further comprise a plurality of pulleys 20, which assist in leveraging the force applied upon the piston and transferred to the cables 15, 16. There may be transfer brackets 24 attached to the frame, and the transfer brackets 24 could be used to assist in maneuvering the tubulars 27 from the trailer 112 to the oil rig pick-up position.

While the above is a description of various embodiments of the presently disclosed device, further modifications may be employed without departing from the spirit and scope of the disclosed device. Thus the scope of the disclosed device should not be limited by the specific structures disclosed. Instead the true scope of the disclosed device should be determined by the appended claims.

What is claimed is:

1. A device for assisting in the loading and off-loading of oil well tubulars from a trailer comprising:
a trailer comprising a frame having a right side and a left side, a bottom side, and a top side defining a bed, the bed comprising a front and a back, wherein a longitudinal axis is defined by the front and the back;
a plurality of ground engaging wheels attached to the trailer bottom side;
a bin comprising a right side and a left side formed by a plurality of upright members attached to the corresponding right and left frame sides;
at least two horizontal pipe support members oriented transverse to the bed of the trailer; and
a raising-lowering means for moving the horizontal pipe support members from a first position adjacent to the bed to a second position above the bed.

2. The apparatus of claim 1 wherein the raising-lowering means for the horizontal pipe support members comprises a ram member comprising an extendable piston.

3. The apparatus of claim 2 wherein the raising-lowering means further comprises a plurality of cable members attached at a first end to the piston, and attached at a second end to the horizontal pipe support members.

4. The apparatus of claim 3 wherein the plurality of cable members comprise a first cable pair attached to a first horizontal pipe support member and a second cable pair attached to a second horizontal pipe support member.

5. The apparatus of claim 3 wherein the raising-lowering means further comprises a plurality of pulleys.

6. The apparatus of claim 1 further comprising transfer brackets attached to the frame.

7. A device for assisting in the loading and off-loading of oil well tubulars from a trailer comprising:
a trailer comprising a frame having a right side and a left side, a bottom side, and a top side defining a bed, the bed comprising a front and a back, wherein a longitudinal axis is defined by the front and the back;
a plurality of ground engaging wheels attached to the trailer bottom side;
a bin comprising a right side and a left side formed by a plurality of upright members attached to the corresponding right and left frame sides;
at least two horizontal pipe support members oriented transverse to the bed of the trailer; and
a raising-lowering means for moving the horizontal pipe support members from a first position adjacent to the bed to a second position above the bed in a generally parallel configuration wherein the horizontal pipe support members are maintained in a generally parallel configuration as they move between the first position and the second position.

8. The apparatus of claim 7 wherein the raising-lowering means further comprises cable members attached at a first end to the piston, and attached at a second end to the horizontal pipe support members.

9. The apparatus of claim 8 wherein the cable members comprise a first cable pair attached to a first horizontal pipe support member and a second cable pair attached to a second horizontal pipe support member.

10. The apparatus of claim 8 wherein the raising-lowering means further comprises a plurality of pulleys.

11. The apparatus of claim 7 further comprising transfer brackets attached to the frame.

12. A device for assisting in the loading and off-loading of oil well tubulars from a trailer comprising:
a trailer comprising a frame having a right side and a left side, a bottom side and a top side defining a bed, the bed comprising a front and a back, wherein a longitudinal axis is defined by the front and the back;
a plurality of ground engaging wheels attached to the trailer bottom side;
a bin comprising a right side and a left side formed by upright members attached to the corresponding right and left frame sides, the upright member located on each side of the trailer, wherein the bin retains the tubulars within the trailer;
at least two horizontal pipe support members oriented transverse to the bed of the trailer, the horizontal pipe support members comprising a left side and a right side; and
a raising-lowering means for moving the horizontal pipe support members from a first position adjacent to the bed to a second position above the bed in a generally parallel configuration wherein the horizontal pipe support members are maintained in a generally parallel configuration as they move between the first position and the second position, the raising-lowering means further comprising a plurality of cable members attached at a first end to the piston, and attached at a second end to the horizontal pipe support members, wherein the plurality of cable members comprise a first cable pair attached to a first horizontal pipe support member and a second cable pair attached to a second horizontal pipe support member.

13. The apparatus of claim 12 wherein the raising-lowering means further comprises a plurality of pulleys disposed between the piston and the horizontal pipe support members, wherein the plurality of cables are routed through the pulleys and attached to the piston and the right sides and the left sides of each of the horizontal pipe support members.

14. The apparatus of claim 12 further comprising transfer brackets attached to the frame.
